(19) United States
(12) Patent Application Publication
(10) Pub. No.: US 2006/0106657 A1
(43) Pub. Date: May 18, 2006

(54) Systems and methods for estimating costs and characteristics of enterprise training facilities

(75) Inventors: Eytan Pollak, Oviedo, FL (US); Gregory A. Harrison, Oviedo, FL (US); John Little, Orlando, FL (US)

Correspondence Address: WELSH & KATZ, LTD, 120 S RIVERSIDE PLAZA, 22ND FLOOR, CHICAGO, IL, 60606, US

(73) Assignee: Lockheed Martin Corporation, Orlando, FL (US)

(21) Appl. No.: 10/990,914

(22) Filed: Nov. 17, 2004

(51) Int. Cl. G06F 9/44

(52) U.S. Cl. 705/7

(57) ABSTRACT

A training enterprise cost estimating system and method to automatically provide an optimized estimate in response to user provided inputs. A user enters enterprise related parameters including types of tasks, types of vehicles, types of simulators, costs, and optimization priorities. The user can carry out simulations of the proposed training system and modify parameters thereof along with obtaining a cost estimate.

### FIELD OF THE INVENTION

The invention pertains to predictive systems and methods for estimating performance and costs of enterprise facilities. More particularly, the invention pertains to user friendly, interactive systems and methods for automatically providing cost estimates in response to user entered parameters which specify, at least in part, training facility characteristics.

### BACKGROUND OF THE INVENTION

The value of using simulators or simulation systems as an alternate to actually carrying out an activity is well known. The advantages of simulating the activity include increased safety, lower costs, and an opportunity to evaluate a plurality of solutions in a relatively short time interval irrespective of whether one or more of the solutions is cost prohibitive or technically unfeasible for any one of a variety of reasons.

For example, training simulators such as disclosed in U.S. Pat. No. 6,106,298 entitled “Reconfigurable Easily Deployable Simulator” which issued Aug. 22, 2000, assigned to the assignee hereof, can be used to improve training efficiencies relative to operating vehicles. Vehicles can include aircraft, watercraft or land vehicles.

It would be desirable to be able to realize some of the advantages of using simulators for carrying out various types of exercises or training in other types of design activities. More particularly, it would be desirable to be able to simulate operational characteristics and project costs for the creation of various kinds of enterprise facilities. These might include, for example, training facilities. Preferably, such simulation systems could be used to cost effectively evaluate a variety of proposed training facilities that are intended to address an outstanding need, and, to assist decision makers in considering various options prior to making a commitment to build any one configuration.

### SUMMARY OF THE INVENTION

Systems and methods which embody the invention include establishing a plurality of training tasks. The tasks are allocated to members of a plurality of media types. At least some of the media types are divided into lessons. Subsequently, a curriculum can be defined and simulated. Optimized estimated cost data for establishing and operating a training facility for the curriculum can be automatically generated. Using an interactive process parameters can be varied and alternative cost estimates can be produced and evaluated.

### BRIEF DESCRIPTION OF THE DRAWINGS

FIG. 1 is a flow diagram illustrating a method in accordance with the invention;

FIG. 2 is a block diagram of a system in accordance with the invention;

FIG. 3 illustrates an initial screen presented by the system of FIG. 2;

FIG. 4 illustrates processing details of a standard objective template module in accordance with the invention;

FIG. 5 illustrates details of a front end analysis tool module in accordance with the invention;

FIG. 6 illustrates details of a solution design tool module in accordance with the invention;

FIG. 7 illustrates details of a media selection module in accordance with the invention;

FIG. 8 illustrates details of a projection tool module in accordance with the invention;

FIG. 8A illustrates an automatically generated exemplary curriculum or schedule;

FIG. 9 illustrates details of a pricing module in accordance with the invention;

FIG. 9A is an example of estimated system pricing;

FIG. 10 illustrates details of an optimizing module in accordance with the invention;

FIG. 10A is a diagram illustrating details of the optimizing process;

FIG. 11 is a block diagram of a simulation system in accordance with the invention;

FIG. 12 illustrates a data structure usable with the system of FIG. 11; and

FIG. 13 is a flow diagram illustrating further aspects of a method in accordance with the invention.

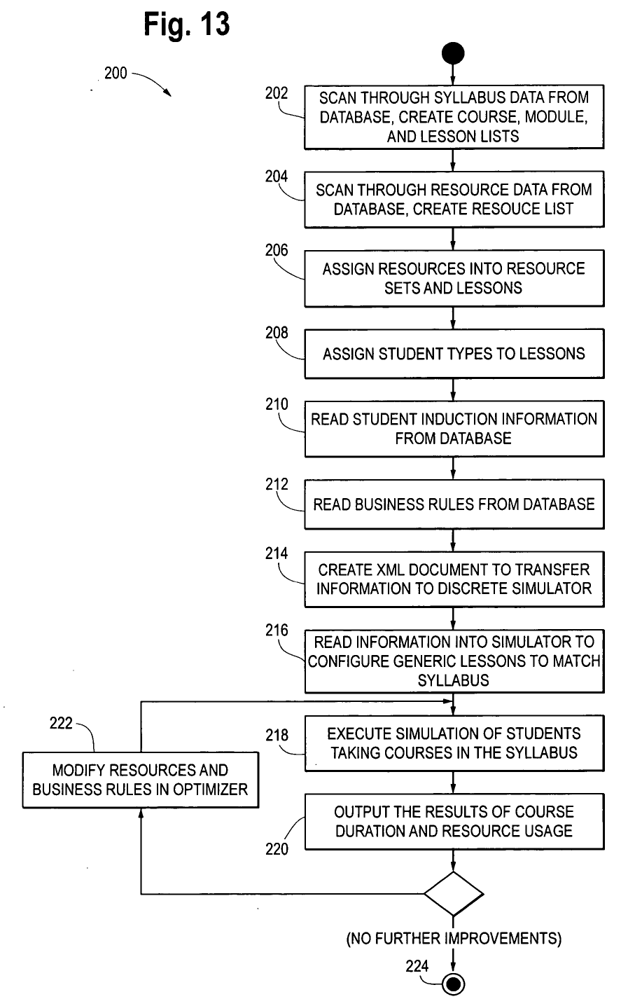

### DETAILED DESCRIPTION OF THE INVENTION

While embodiments of this invention can take many different forms, specific embodiments thereof are shown in the drawings and will be described herein in detail with the understanding that the present disclosure is to be considered as an exemplification of the principles of the invention, and as a disclosure of the best mode of practicing the invention. It is not intended to limit the invention to the specific embodiment illustrated.

A method which embodies the invention executes a plurality of steps based on training and facility input parameters to create a discrete simulation of a projected training system. The system simulation can be executed and costs therefore can be calculated and projected. The simulated system can be optimized in accordance with predetermined criteria to produce a plurality of optimized parameters. The discrete simulation can be conducted again to produce optimized costs and system characteristics.

Overall costs of a method in accordance with the invention of a newly defined training system can be estimated from individual cost contributions such as costs to create lessons, simulator usage costs, other equipment usage costs, recurring and nonrecurring cost estimates. The method and system can respond to financial data, media data, syllabus data, distance rules and performance data.

A system which embodies the invention will predict the costs for certain optimal training system configurations prior to making the expenses. In the process, the method and system carry out optimization of the proposed design.

In one aspect of the invention, various rules are provided to guide development of the proposed system. Such rules can incorporate fuzzy logic-type processing.

In another aspect of the invention, local optimization can be performed at each processing level. Global optimization enables the method and system to incorporate changes from one level of processing into changes in another level.

In yet another aspect, the present system and method estimate the performance and costs of a proposed training system. This process includes selection of courses, syllabus, student training rates as well as necessary equipment. A discrete simulator system is incorporated which can be automatically programmed from results of rule based creation of the syllabus as well as computer selected media choices. The simulator automatically tests individual solutions and provides a level of optimization.

The present system and method provide a multi-stage framework and tool to assist in the automation of media selection, sizing analysis and optimization. The system and method propose a plurality of iterative solutions which provide one or more optimized choices.

In yet another aspect, the present method automatically configures a simulation using external data that interfaces to generic processing flow software. The generic software models incorporate ports or slots for receipt of external data.

The configurable data slots define aspects of the model. These include resources that are required, the amount of time different operations within the model would take, and other required configurations, such as the model's hierarchical position in the overall architecture.

In prior art systems, once the generic models were entered through the visual interface, they would be unchangeable. The methods described herein overcome this prior art deficiency. The present method enables use of the capabilities of a visual-user-interface-programmed discrete simulator. Additionally, the settings of all the individual models therein can be controlled using configuration data from a source outside the program.

Exemplary languages that could be used include Visual Basic, Applications Edition, or VBA and the Extensible Markup Language, XML, including the XML schema capabilities. These facilitate the transfer of large amounts of articulated data right into a simulator. One discrete event simulator that can be used is the Arena simulator, from Rockwell Software. Other simulators could also be used without departing from the spirit and scope of the invention.

A workflow system can be used to sequence all the various software applications, and to pass the data from one application to the next. This workflow preferably can proceed in a completely automatic manner. The Java programming language can be used to interface with the database to create the XML data to be passed to the VBA input to the discrete event simulator.

In accordance with the invention a generic model of an enterprise training system is subsequently disclosed and described. An enterprise training system could be viewed as a schoolhouse, having students, lessons, syllabi, and resources. One form of training is helicopter flight training. The students would come to the school daily, and take the lessons that were specified by the syllabus for the course they were in. A detailed syllabus can be simulated for a proposed enterprise training system.

Students would take lessons as set forth by a specific curriculum. A plethora of course, lesson and student data can be populated all within the generic discrete event simulation model turning it into a run-time specific model.

Different types of lessons can be modeled, such as instructor-led, computer-based training, and flying lessons. Each type of lesson had its own set of control variables that were set using data from the database. These variables would include what resources were required, and how long each section of the lesson takes, such as time to drive to the airfield, and how long to fly.

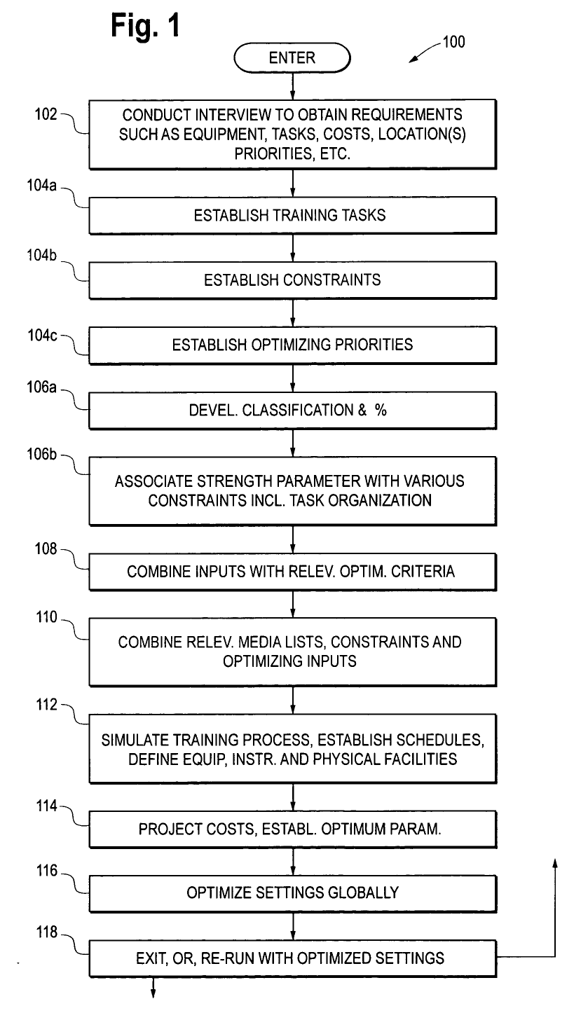

FIG. 1 illustrates a flow diagram of an exemplary method 100 in accordance with the invention. The method 100 in particular simulates a form of a helicopter flight training system. In a step 102, one or more interviews can be conducted to obtain requirements such as equipment, tasks to be carried out in the training process, costs, locations and priorities (the business rules).

From the data collected during the interview(s), in a step 104a, the appropriate training tasks are established. In a step 104b business rules including costs and resources available to aid in accomplishing the tasks are established. The business rules represent global constraints relative to the method.

In step 104c optimization priorities are defined. These priorities can be used to establish a more optimal projecting and costing solution.

As a result of carrying out steps 104a, b, and c, a task listing can be established as well as a set of constraints and associated restraints relative thereto. Outputs from the steps 104a, b, c are processed in steps 106a, b to produce an expanded or enhanced task list having individual tasks classified or defined as percentages of types of activities such as knowledge cognitive, psychomotor or affective.

In step 106b an associated constraint and prerequisite list can be established. This list associates constraints as well as task organization, which establishes prerequisites, with strength indicia.

Outputs from prior steps are further processed, step 108, to specify specific media required to accomplish each task as well as approximate number required and whether or not the media are preexisting. Newly created courses can be associated with course name, type and duration from previously known similar courses.

Step 108 produces a detailed media list needed to accomplish each task. Each task is associated with media type courses need to carry out the specific task.

Multiple sets of solutions can be created to train each task based on different media. Random sets of solutions can be created in response to probabilities set by a global optimizer.

In step 110, prior outputs are processed further to produce a detailed media list which includes specific lessons and durations. Constraints and prerequisites can be identified as well as associated with various strength indicia. A training schedule can be populated with the actual lessons required for all tasks.

Where tasks overlap, lessons can be combined to provide the fewest training lessons to successfully complete all of the required tasks. Appropriate existing lessons from the course inventory can be selected and incorporated. Otherwise additional specific lessons can be created.

In step 112, prior outputs are processed further to simulate the current system including establishing schedules, defining equipment, instructions, physical facilities and the like to implement the system. A preliminary training curriculum schedule can be established all responsive to local optimization. Measures of the system performance can be established. The number of students trainable per year can be calculated, training time, number of instructors needed to complete various tasks and the utilization of resources can be defined.

The prototype system can be tested to determine if it can support the syllabus including, determining if the system can support the number of students to be trained per year, determining resource idle time, and duration of training lessons. Projected performance can also be evaluated.

In step 114, yearly income and expenses of the current solution can be calculated including system recurring and non-recurring costs. Costs per student can be determined. Optimization parameters can be identified and their values established based on estimated resulting costs and other input data.

In step 116, prior inputs along with optimization priorities from the business rules can be further processed so as to synchronize and control all of the local optimizations associated with the various prior steps. Optimization effects can be further evaluated. The optimizing process can adjust, based on user input and the current training schedule, resource utilization, system performance and resulting costs. Responsive to user established optimization priorities, a score can be established which increases each time a solution comes closer to or exceeds the optimization priorities.

The proposed system can be expanded optimally until the required number of students per year are taught. A system of a given size can be optimized for effectiveness, cost and/or training time. Optimal expansion can include increasing resources with zero idle time. Various solutions that yield the desired number of students, such as per year, can be selected and evaluated.

In step 118 the process can be concluded if the currently proposed system is adequate or acceptable. Alternately, further iterations can be undertaken so as to arrive at a more optimal solution.

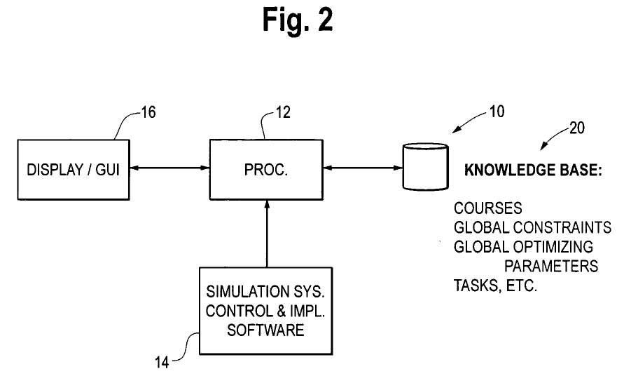

The process 100 of FIG. 1 can be implemented with a system 10 illustrated in FIG. 2. The system 10 includes one or more programmable processors 12 and simulation, system control and implementation software 14 which can be stored in a computer readable medium such as a disk drive.

System 10 also includes a display and associated graphical user interface (GUI) software 16 which can present a graphical user's interface enabling the user to interact with the system. Processor 10 is also in communication with a knowledge base 20 which would also be storable on a computer readable medium. The knowledge base 20, for example, a relational data base, includes pre-run data, statistics, post-run results, information pertaining to courses, global constraints, global optimization parameters, tasks and the like. The knowledge base 20 is usable by all modules in carrying out their respective processing.

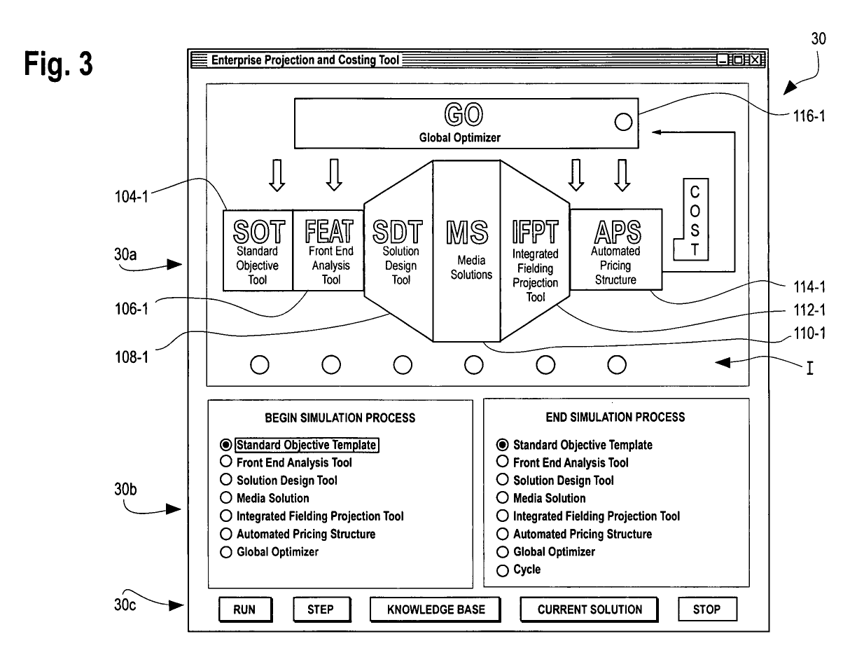

FIGS. 3-10 illustrate additional details of the method 100 including various of the displays presented to a system user via the display/graphical user interface 16 along with processing results. The following functional characteristics can be implemented using a variety of software languages, existing packages, expert systems, fuzzy logic-type processing systems, neural networks and the like all without limitation. Those of skill will understand that the implementation details of process steps 104 . . . 116 and implementing modules 104-1 . . . 116-1 are not limitations of the present invention.

FIG. 3 illustrates an initial screen 30 presented on the display and graphical user interface 16 for a user. The display 30 presents each of the modules such as Input Module 104-1, Analysis Module 106-1, Design Module 108-1, Media Module 110-1, Projection Module 112-1, Pricing Module 114-1 and Optimizer Module 116-1 which implement respective steps of FIG. 1 discussed previously. As discussed subsequently, each of those modules can be selected for execution. Alternately, the entire system can be executed.

Associated with each of the modules is an indicator, generally indicated at I, which is activated, or lit, when the associated module is idle. The indicator is dark when the simulation is active within that module.

Once the simulation process has reached the global optimizer module 116-1 and the optimizer has developed a new set of parameters or conditions, the indicator light for the input module 104-1 is again activated. The indicator for module 104-1 goes dark and the entire process is re-executed using new conditions provided by the optimizer module 116-1. This process will continue until an optimum solution has been reached.

The simulation process panels (30b) indicate the requested start and end point of the current simulation run by the user. This enables the user to re-run the entire process or a single module if desired. To run a single module, the begin and end point radio, or light, buttons must indicate the same process. To run from front to end the Standard Objective Template must be selected as the beginning module. The Global Optimizer must be selected as the end module.

Light buttons 30c enable a user to control the simulation process as follows:

RUN—Runs the simulation from the specified process or processes specified by the Simulation Process Panels. Choosing the RUN command prevents the simulation from pausing during each simulation except for modules that require user input (Objective Template Module 104-1 and Front End Analysis Tool Module 106-1). RUN will continue without pause until the simulation process has completed or the STOP command has been chosen.

STEP—Runs the simulation from the specified process or processes specified by the Simulation Process Panels. Choosing the STEP command permits the user to pause each module after execution to analyze each segment's input and/or output. To continue to the next segment, the user may choose the RUN or STEP command, however if the RUN command is chosen, the user will not be able to STEP until the simulation process has completed or the STOP command has been chosen.

KNOWLEDGE BASE—Enables the user to view and input data into the current Knowledge Base 20 such as courses, global constraints, and global optimization parameters.

CURRENT SOLUTION—Enables the user to view results of the current solution constructed by the user created task list. It also enables the user to input new tasks.

STOP—Allows the user to stop the simulation while the system is running.

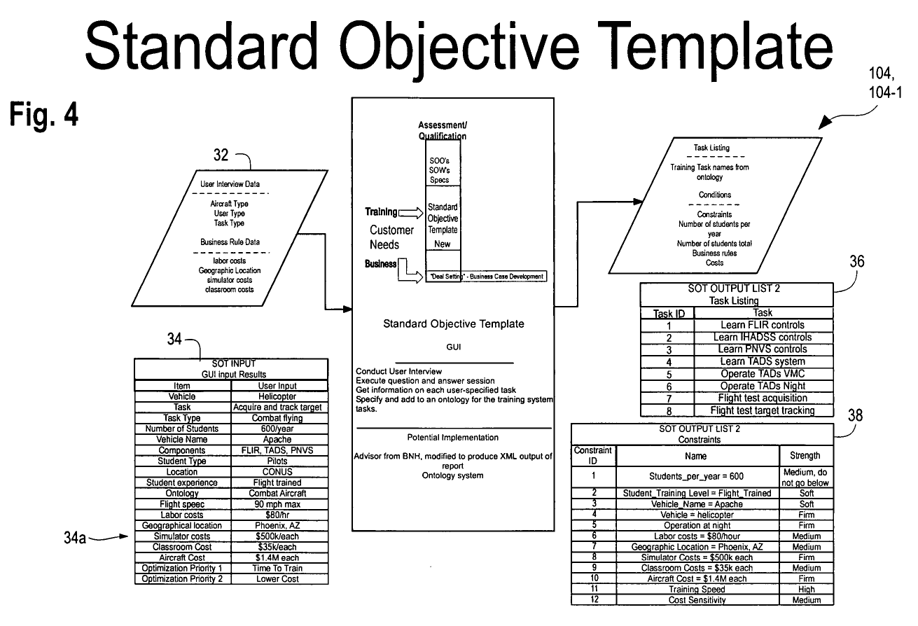

FIG. 4 illustrates various additional aspects of the step 104, implemented by Input Module 104-1. As illustrated in FIG. 4, user interview data and business rule data, reflective of customer needs, indicated generally at 32 are converted to equipment, task related information, cost information and priority information, 34. This information is entered into the system 10 via the display/GUI 16 and processed by module 104-1, in combination with information from knowledge base 20, to produce a task output list 36 and a constraint output list 38.

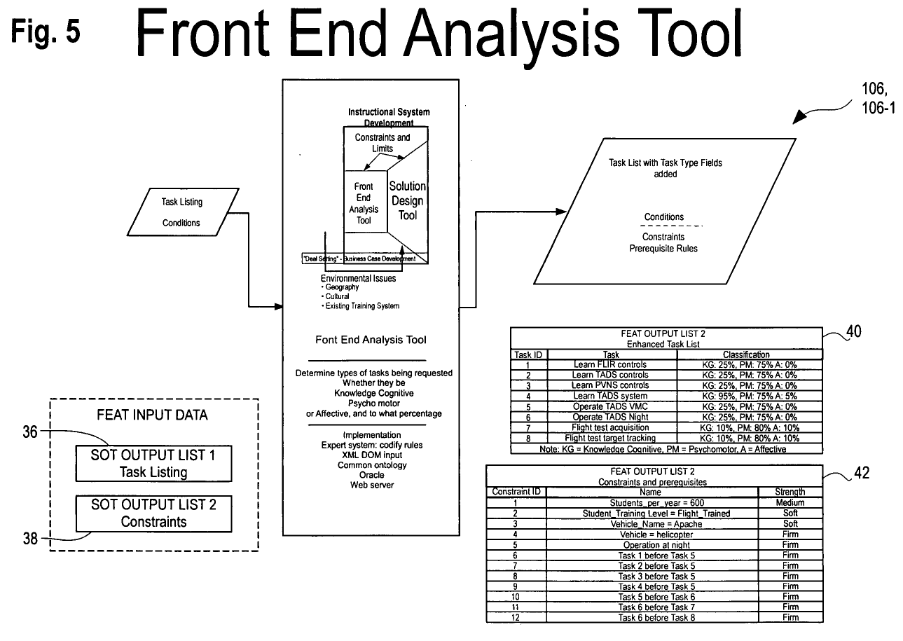

The information from lists 36, 38 is in turn coupled to Analysis Module 106-1, FIG. 5, which implements step 106. Module 106-1 processes the input data from lists 36, 38 to produce an enhanced task output list 40 which associates percentage type classifications with each of the tasks. The same processing also results in production of a constraint and prerequisite list 42 which identifies a plurality of constraints, prerequisite rules defining the order of implementation of tasks as well as constraint strength indicia.

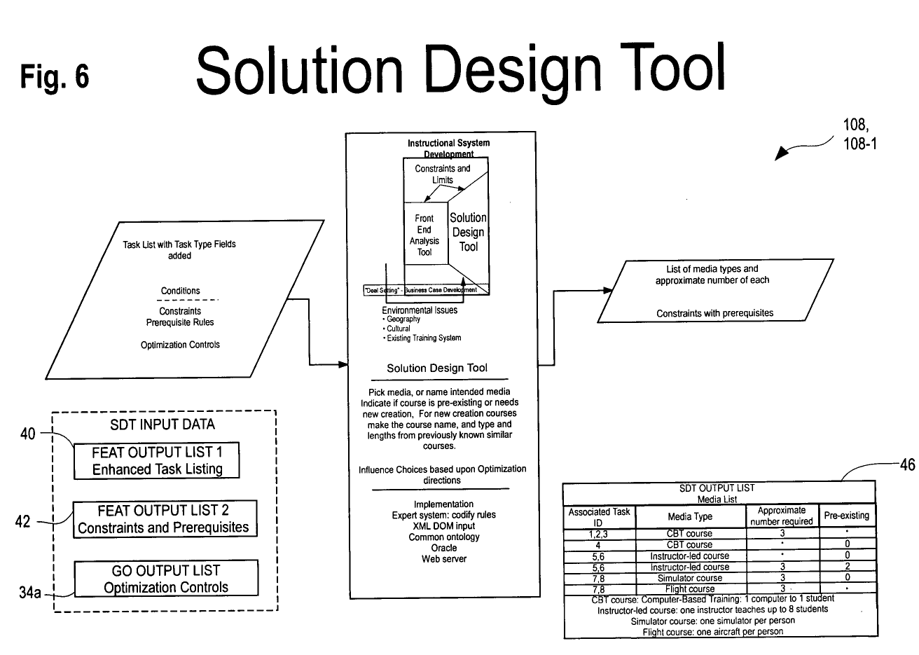

Outputs from the Analysis Module 106-1 are coupled to the Solution Design Tool Module 108-1, FIG. 6 to implement step 108. Data from lists 40, 42 and optimization information, such as 34a are further processed to produce media list 46. The list 46 associates preestablished tasks with various types of media and establishes the number required and determines whether any are preexisting.

In summary, the Solution Design Tool Module 108-1, selects a set of training media to teach a given task. It can create multiple sets of solutions to train the task, based on different media, including random sets, with probabilities controlled by the global optimizer, module 116-1 discussed subsequently. The module 108-1 also checks each solution for its ability to satisfy the task goals for knowledge, psychomotor, and effective training mix. A solution score is formed. Each acceptable media set is weighted by optimizer priorities. The highest scoring media set or list is chosen as a solution.

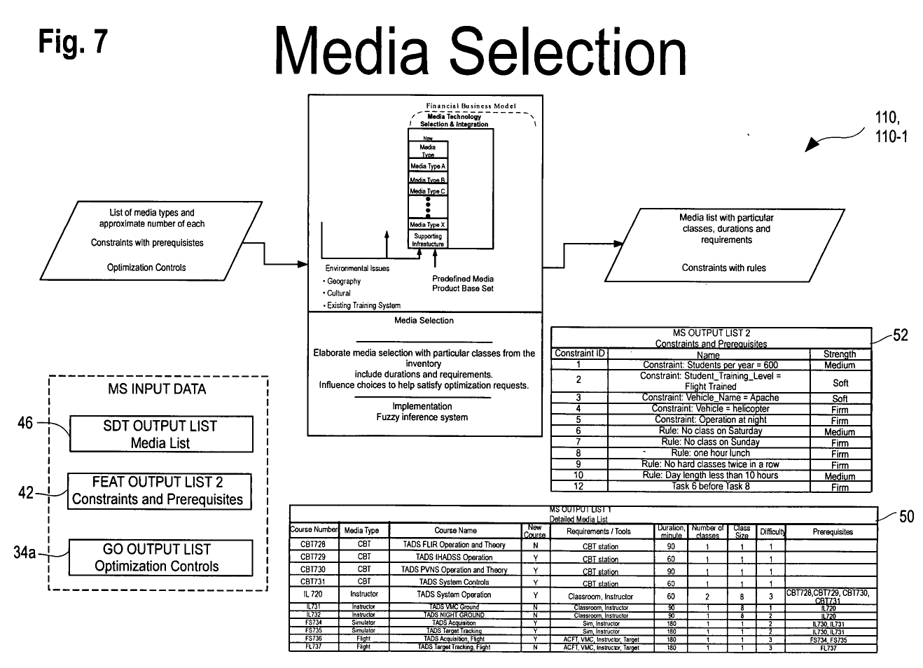

Outputs from Design Module 108-1, FIG. 6 are coupled to Media Selection Module 110-1, FIG. 7 to implement step 110. Inputs to the Selection Module 110-1 include media output list 46, constraint prerequisite list 42 as well as optimization indicia such as 34a. Selection Module 110-1 processes the subject inputs and produces an expanded more detailed media list which provides a list of courses, requirements, durations, instructors and related information 50. The Selection Module 118-1 also produces an expanded constraint and strength list 52.

Given the chosen solution, the Media Selection Module 110-1 assigns course numbers to each media choice. It searches the course inventory, database 20, to find courses having matching properties. If no course is found, it creates a course name and number, and makes the course “to be developed” and places it in inventory and in the developing solution. A syllabus for the training program is the result of processing all tasks.

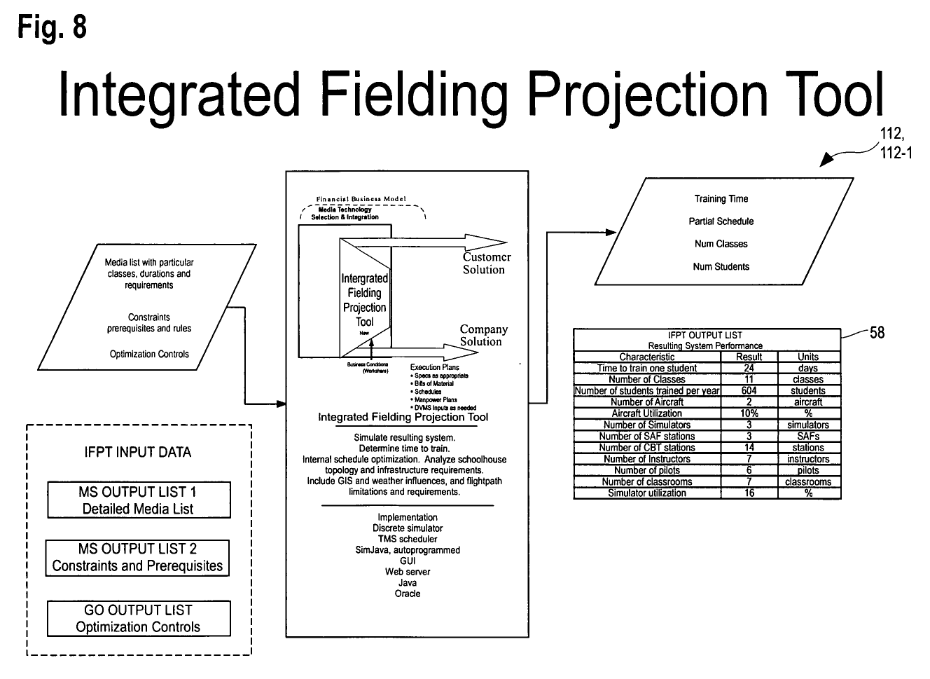

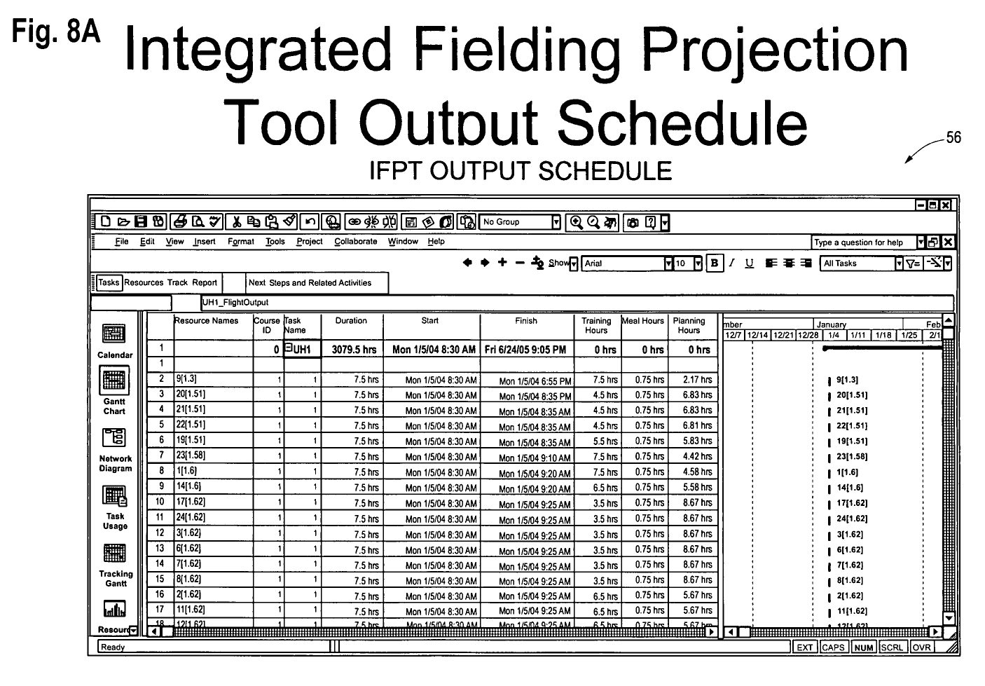

Outputs from the Selection Module 110-1 are coupled to Integrated Fielding Projection Module 112-1, FIG. 8 to implement step 112. The module 112-1 simulates the proposed system, produces a curriculum or schedule 56, see FIG. 8A, for an exemplary schedule. It also generates information pertaining to simulated system performance 58. The schedule 56 can be optimized to minimize the number of training lessons and time. Performance information 58 includes time to train a student, number of lessons, students trained per year, and additional performance information of interest.

Module 112-1, in summary, creates a prototype of the desired system. It evaluates the prototype for its ability to support the syllabus to available resources. It determines if the number of students to be trained per year can be supported by the proposed system. It will also determine idle time for system resources and determine the duration of the training course.

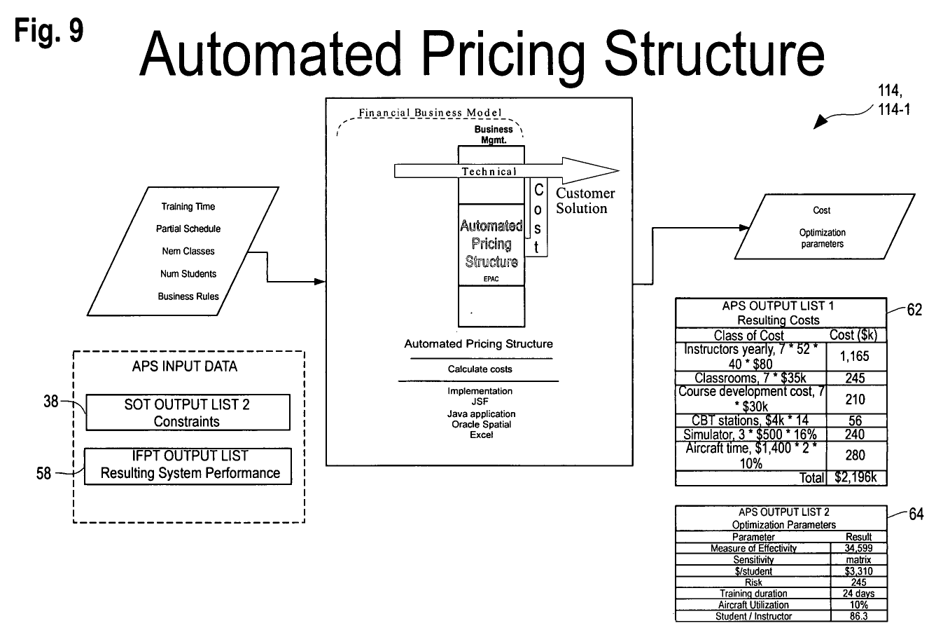

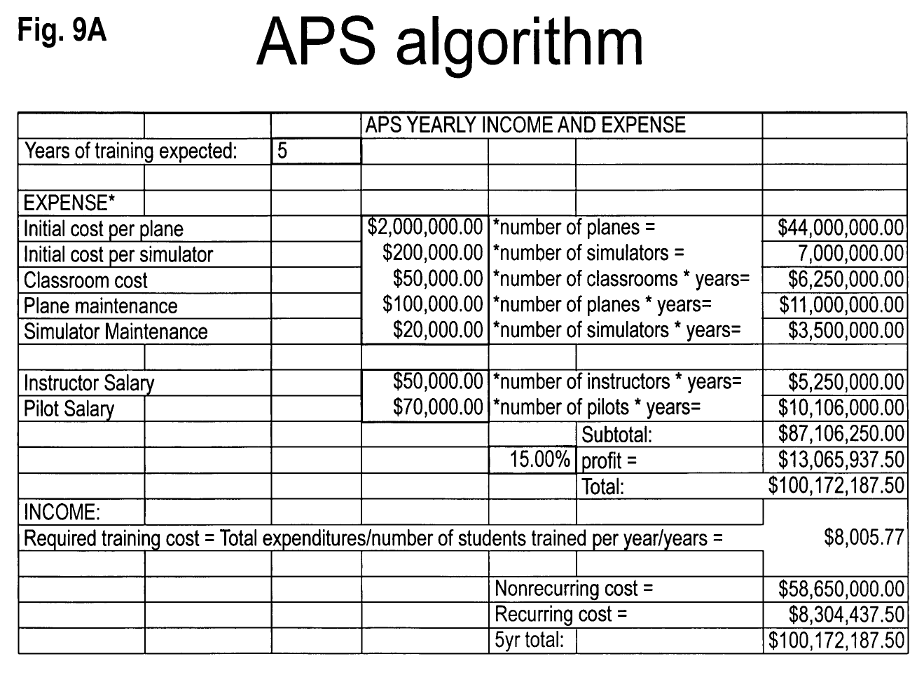

Pricing module 114-1 calculates the estimated total recurring and non-recurring cost of the proposed system. It can also calculate the cost per student. FIG. 9A illustrates exemplary cost information which might be generated by module 114-1.

Previously produced information, including output list 38 from SOT module 104-4, and output list 58 from Projection Module 112-1 are processed by Pricing Module 114-1, FIG. 9, to implement step 114. Cost estimation information 62 for the simulated system as well as optimization parameters 64 are output by module 114-1.

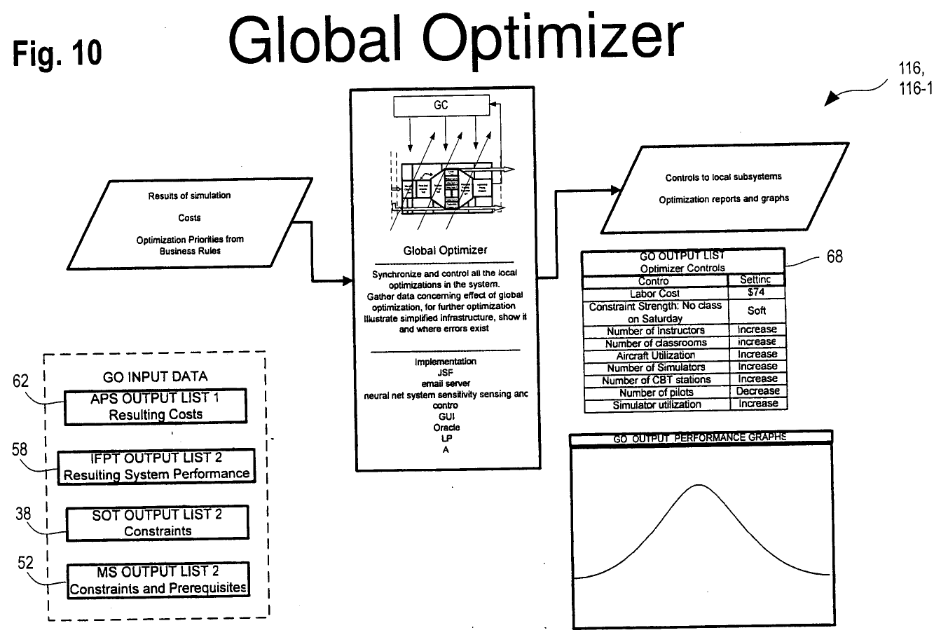

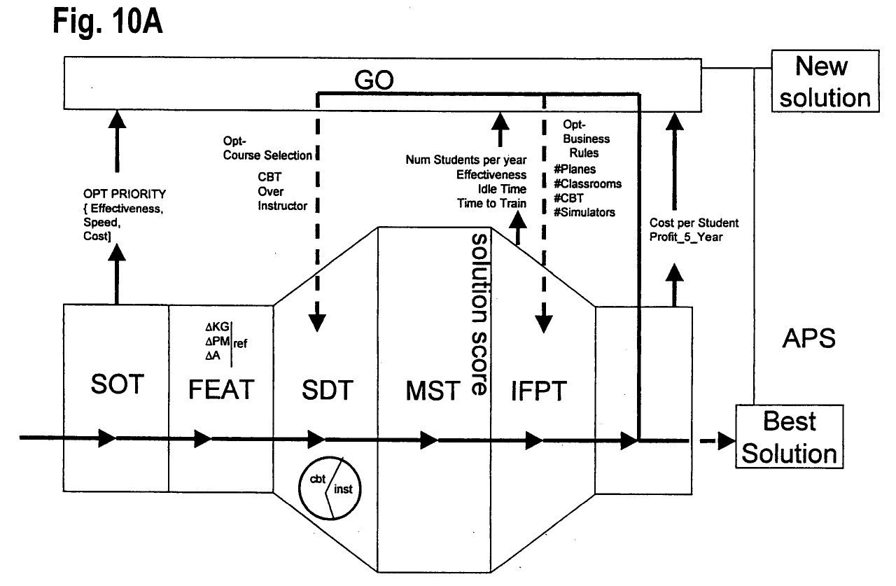

Previously processed data including cost output list 62, IFPT module performance output list 58, SOT module constraint output list 38 and MS output list 52 are in turn coupled to global optimizer module 116-1 to implement steps 116, FIG. 10. Module 116-1 produces global output lists, and optimizer controls 68 which can be the basis of the next simulation iteration.

Parameter results from the latest simulation can be used as a basis for the next iteration. When one or more satisfactory solutions have been achieved, the process can be terminated and a decision can be made. The decision could be to proceed with plans to implement the solution. Alternately, more simulations can be run, with varied parameters, to attempt to arrive at a more optimal result.

The optimizer module 116-1 carries onto a two-part optimization. It expands the proposed system until the required number of students per year can be taught by increasing those resources with zero idle time. It can then optimize the proposed system relative to one or more of effectiveness, time to train and/or cost. FIG. 10A illustrates aspects of the optimizing process. Newly obtained optimized values can be fed back into the system and the simulation process repeated to obtain another set of values. A user thus cannot only obtain a set of optimal system values, the values can be varied to carry out “what-if” scenarios.

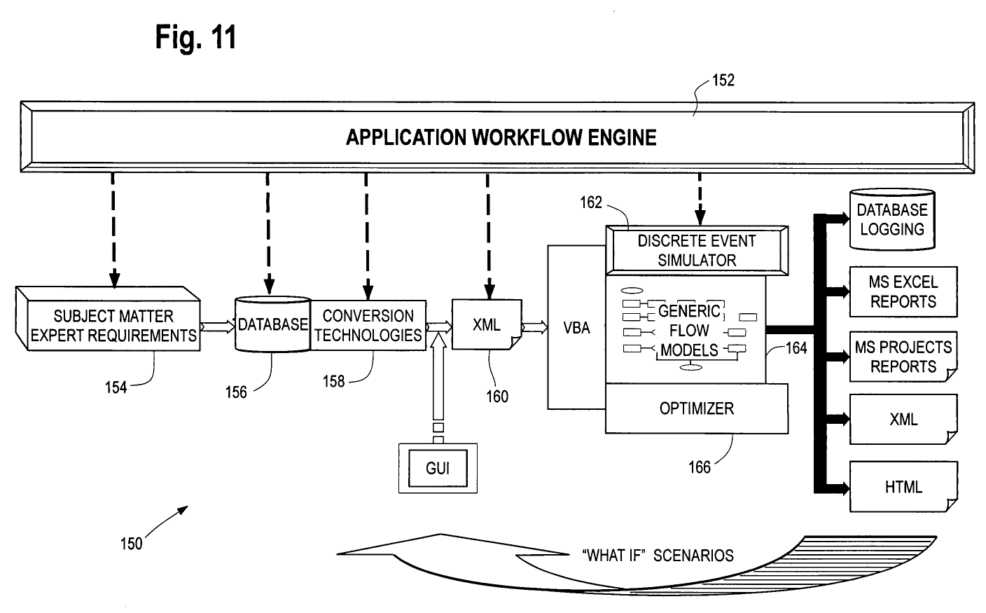

FIG. 11 illustrates a system 150 of a type which can be used to carry out a variety of enterprise simulations, including system 10 and method 100 described above. Other types of enterprise simulations that can be implemented using system 150 include integrated training centers, airfield simulations, aircraft logistics and maintenance systems simulations.

In another aspect of the invention, a workflow engine 152, a collection of tasks, can be organized into, and associated with, a collaborated set of resources or assets. It controls the execution of a selected business process by triggering, through application automation, all tools and processes in the overall application. This methodology not only triggers one application after another in order, but also includes using the output of one sequential application as the input to another.

The workflow process can start with a Java language GUI that enables predetermined choices to be selected. These choices can, for example, include whether or not to optimize the internal simulation output, to permit what-if scenarios to be run, or to view runtime simulation animation.

The first software element in the workflow process could be a requirement analysis tool 154 usable to enter pre-selected data into the Server databases 156. Once the data has been populated within the databases the workflow would trigger stored procedures, Explicit XML and conversion software 158 to create a complete XML file 160. The workflow engine 152 would then write the XML file to disk to be used as an input to the discrete event simulator 162.

During and after the simulation runs, the discrete event simulator can write student logs, create plots and graphs, and web deployable reports, as outputs. After the simulation runs to completion these outputs can be presented visually by having the workflow engine automatically bring up these various applications. Also, if the selection was made in the beginning of the workflow run to allow for what-if scenarios, the workflow would then present the user with more Java GUIs. This allows the user to make changes to the database entries or the XML directly, and then perform a new full simulation run.

Workflow Engine 152 can be implemented with a WfMOpen workflow engine which can be based on WFMC, a GNU Licensed Open Source standard. WfMOpen also implements the XPDL, or XML Process Definition Language which is included in the same standard. XPDL provides a framework for implementing business process management and workflow engines.

Visual Basic, Applications Edition, or VBA, is a Microsoft® derivative of the Visual Basic programming language that enables its host application to interoperate with the Microsoft® Windows Platform Environment. VBA can be used to create a generic, customizable XML parser via the MSXML parsing framework.

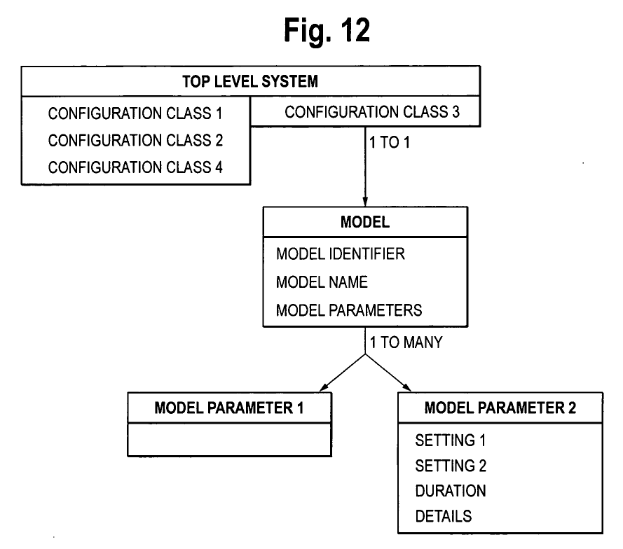

Using Visual Basic coding standards, object Issons and data structure can be created, in order to map, and hold within memory, all of the pertinent data from the XML file 160. Typically, parent tags within the XML can be mapped to Visual Basic lesson names, and the children tags are mapped to class member variables. These data structures can be not only used for reference, but also to populate all applicable variables and modeling object constructs within the Discrete Event Simulation. The organization of these data structures is illustrated in FIG. 12.

Discrete Event Simulation models a system as it evolves over time by representing any changes within the system as separate events. The simulator 162 can be implemented using the Arena® simulator, a commercially available simulator. Any simulator that has a versatile VBA standard interface and graphical nature for building small to large scale models could be used.

The user interface includes a drag and drop mechanism for creating and populating all “modules” or “blocks” within the model. The model includes one or more process flows much like that of a flow-chart. As the entity, or actor, moves through the flow it will enter model object constructs such as 1-to-many decisions, processes where resources can be seized and utilized, delays consisting of both static digits and random statistical distributions, and output modules where numerical data can be captured and written out to disk in many different mediums.

Because the XML data being is populated into VBA lessons and sublessons, all the data is within the discrete event simulator's memory. During runtime, but before the simulation begins, the generic process models 164 can be modified using the aforementioned data. Resources can be given specific names, costing data, and capacities. Internal variables, expressions and process delays can be populated with static numerical data, or random statistical distributions that are specific to the given dataset. As discussed above, an entire specific curriculum with a plethora of course, lesson and student data can be populated all within the generic discrete event simulation model turning it into a runtime specific model. Results can be optimized using optimizer 166. In addition, the database 156 can be updated with feedback from the simulation(s).

Due to the VBA coding interface the outputs can, for example, be in the form of Microsoft® Excel spreadsheets using the Microsoft® standard ODBS object. By having the discrete event simulation write to the same area in an Excel spreadsheet between simulation runs, dynamic graphs and plots can be generated. The outputs can also be written out to an XML schema for use within other applications, or to be deployed over the web. HTML can be written to disclose the output data in a standard web format for viewing over the web. Standard comma delimited data can also be written out to be utilized within other applications such as Microsoft®Project for illustrating the progression and traceability of events.

In the processing 200 of the system 150, various sets of data are read from the database of information containing the syllabus and training system configuration data as illustrated at 202-212. These data sets comprise the lesson, module, and course information, the student induction rates and amounts, the resource available capacities, and various business rules concerning resource costs and availabilities. This information is processed to permit representation as an XML file that adheres to an XML schema that specifies the location of different types of information. This XML file is stored on disk for access by the discrete simulator as at 214.

The discrete simulator parses through the XML file, and configures internal states, resource sets, and linkages between lessons. Students are then generated, with information on which course they have to complete. They enter a course and begin the first module, where they are assigned a set of lessons to complete. They join the first lesson that is available having enough resources to begin, and spend their time in that lesson, after which they mark that lesson complete and move to the next available lesson. They must complete each module, eventually graduating after completing the final lesson of the final module in the course. Data are recorded about the progress of each student and the average course durations and resource usages.

In step 216 the lesson information is read and processed to configure the generic simulator, such as simulator 162, into a specific instance of an Enterprise Training System having a particular structure and characteristics. It includes courses, modules, lessons, prerequisites, student type requirements, resource type requirements and availabilities in accordance with available input data. Compared to prior art systems, almost no human intervention is needed to make changes, whether these are changes in structure, changes in types, or changes in amounts. The simulator 162 is thus programmed to provide a set of structures that may be allocated to different Enterprise Training System configurations.

After all the students have been trained, for example as at 218, the simulation outputs results, at 220. The various results are available to the optimizer. The optimizer modifies different controls, as at 222 such as the amount of certain resources, and reruns the simulation. This continues multiple times until the most optimum state is reached. Output information is generated, and the processing 200 is completed, as at 224.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. An estimation method comprising:
establishing a plurality of training tasks;
allocating the tasks to members of a plurality of media types;
dividing at least some of the media types into lessons;
responsive to dividing, defining and simulating a curriculum; and generating cost data.

2. A method as in claim 1 which includes, responsive to cost data, making adjustments to at least some of the parameters and repeating at least some of the establishing, allocating, dividing or defining and simulating steps.

3. A method as in claim 2 which includes optimizing costs as a function of at least some of classes, curriculum, equipment, numbers of trainees, and training duration.

4. A method as in claim 1 which includes modifying selected parameters and repeating at least some of the establishing, allocating, dividing or defining and simulating steps.

5. A method as in claim 4 where establishing includes providing a set of task establishing input parameters.

6. A method as in claim 5 where providing input parameters includes specifying at least some of vehicle type, vehicle function, number of students, student type, student experience, location, and training related costs.

7. A method as in claim 6 where establishing costs includes at least some of establishing labor costs, simulator costs, classroom costs or vehicle costs.

8. A method as in claim 5 which includes processing the input parameters to provide the plurality of training tasks.

9. A method as in claim 8 where parameter processing includes establishing a set of constraints.

10. A method as in claim 9 where constraint establishing includes specifying strength indicia and associating same with the set of constraints.

11. A method as in claim 10 where establishing input parameters includes specifying at least some of vehicle type, vehicle function, number of students, student type, student experience, location, and training related costs.

12. A method as in claim 11 where establishing training related costs includes at least some of establishing labor costs, simulator costs, classroom costs or vehicle costs.

13. A method as in claim 10 which includes characterizing the training tasks as being at least one of knowledge cognitive, psycho motor, or affective.

14. A method as in claim 10 which includes characterizing the training tasks as having a composite of type characteristics.

15. A method as in claim 14 where the type characteristics are selected from a class which includes knowledge cognitive, psycho motor or affective.

16. A method as in claim 15 which includes associating tasks with the type characteristics and allocating percentages of task type characteristics to at least some of the tasks.

17. A method as in claim 15 which includes defining prerequisites for at least some of the tasks.

18. A method as in claim 1 where allocating includes associating each task with at least one media type.

19. A method as in claim 18 which includes estimating a number of media types in response to associating the tasks with the media types.

20. A method as in claim 16 where allocating includes associating each task with at least one media type.

21. A method as in claim 20 which includes estimating a number of required media types in response to associating the tasks with the media types.

22. A method as in claim 19 which includes dividing the estimated media types into a plurality of respective lessons with durations and requirements.

23. A method as in claim 1 where defining includes establishing training times and class schedules.

24. A method as in claim 22 where defining includes establishing training times and class schedules.

25. A method as in claim 24 where simulating includes at least some of determining training times, optimizing schedules, adjusting location, type or number of media.

26. A method as in claim 25 where the cost data is estimated in response to simulating the curriculum.

27. A method as in claim 26 which includes revising the curriculum in response to the estimated cost data.

28. A method as in claim 26 which includes optimizing in response to selected parameters.

29. A method as in claim 28 where the parameters include at least some of number of instructors, number of class rooms, vehicle utilization, number of vehicles, simulator utilization, number of simulators, number of students, training duration and scheduling.

30. An estimating system comprising:
software for receipt of parameters of a proposed training facility;
software for defining a set of training tasks in response, at least in part, to the entered parameters;
software for combining the training tasks with information pertaining at least to vehicles and simulators thereof and generating therefrom a lesson based curriculum for implementing selected training; and
software enabling a user to simulate operation of the facility and the curriculum.

31. A system as in claim 30 which includes added software whereby a user can conduct multiple simulations, responsive to various sets of parameters, and evaluate facility performance.

32. A system as in claim 31 which includes cost estimating software responsive to at least one set of parameters to evaluate projected facility costs.

33. A system as in claim 32 whereby the user can produce multiple, optimized cost estimates in response to multiple sets of parameters.

34. A system as in claim 31 where the added software optimizes at least some of the simulations in accordance with predetermined criteria.

35. A system as in claim 31 which includes graphical user interface software for parameter entry comprising at least some of task information, business rules or constraints.

36. A system as in claim 31 where the software for defining comprises a task editor.

37. A system in claim 31 where the software for combining includes software to select a set of training media to teach at least one task.

38. A system as in claim 31 where the software for combining includes software to create multiple sets of solutions to provide training for at least one task.

39. A system as in claim 31 where the software for combining includes software to evaluate the multiple sets of solutions relative to at least some of the parameters.

40. A system as in claim 31 where the software for combining includes software to define courses for implementing each class.

41. A system as in claim 31 where the enabling software includes software for evaluating the simulated facility and curriculum.

42. A system as in claim 31 which includes cost estimating software.

43. A system as in claim 41 which includes cost estimating software.

44. A system as in claim 31 which includes optimizing software.

45. A training facility data base storable on a computer readable medium comprising:
information defining a plurality of training related tasks;
information defining a plurality of media types;
information pertaining to characteristics of members of the plurality of media types;
information pertaining to lessons for implementing the tasks; and
information pertaining to training related costs.

46. An enterprise simulation system comprising:
requirements analysis software;
a database to receive inputs from the analysis software;
input software to populate a plurality of generic flow models with training system specifying data; and
a discrete event simulator to carry out a training system simulation.

47. A system as in claim 46 which includes optimizer software for establishing a new set of simulation conditions.

48. A system as in claim 47 which includes report generation software.
